(19) United States
(12) Patent Application Publication
(10) Pub. No.: US 2018/0295863 A1
(43) Pub. Date: Oct. 18, 2018

(54) Composition and Method of Preparing Non-Alcoholic Beverage Mixer

(71) Applicants: Richard Ojeda, Los Angeles, CA (US); Gerardo Magallanes, Indio, CA (US)

(72) Inventors: Richard Ojeda, Los Angeles, CA (US); Gerardo Magallanes, Indio, CA (US)

(21) Appl. No.: 15/488,207

(22) Filed: Apr. 14, 2017

(51) Int. Cl. A23L 2/06; C12G 3/06; C12C 5/02; C12G 1/00

(52) U.S. Cl. CPC A23L 2/06; C12G 3/06; A23V 2002/00; C12G 1/00; C12C 5/026

(57) ABSTRACT

Disclosed herein are beverage compositions comprising a measured amount of lime juice, chili peppers and salt. The beverage composition to be marketed and sold as a non-alcoholic mixer for the subsequent addition of an alcoholic beverage, including beer and spirits. The beverage composition may also be sold with alcohol so that the addition of alcohol is not required. The composition is formulated to appeal to the desire for sour and spicy flavors in alcoholic drinks.

### BACKGROUND

Mixed drinks are beverages that are prepared by combining two or more ingredients with alcohol before consuming. Packaged non-alcoholic mixers are compositions of one or more ingredients that may be subsequently mixed with alcohol and consumed as a specialty beverage. Mixers are combined with beer, wine or spirits to create a pleasant flavor for various alcoholic drinks. Several mixes exist that combine natural juices or artificial flavors with alcohol to create popular beverages. Pre-packaged mixes are a convenient and inexpensive way to enjoy a specialty beverage at any time. Tomato juice, orange juice and pineapple juice are some fruit juices used to create non-alcoholic mixes that are typically combined with alcohol to create sweet or tart flavors for specialty alcoholic beverages.

What is needed is a composition that appeals to other desirable tastes, including sour and spicy flavors, which can be added to alcoholic beverages and enjoyed at any time.

### SUMMARY

Disclosed herein is a non-alcoholic beverage composition comprising fruit juice and one or more varieties of chili peppers to be subsequently mixed with alcohol and consumed as a specialty beverage. Fruit juice is mixed with one or more varieties of chili peppers and, in a preferred embodiment of the present invention, fruit juice is combined with one or more varieties of chili peppers, salt and beer to be consumed as an alcoholic beverage.

In another embodiment of the present invention, a non-alcoholic beverage composition comprises a citrus juice and one or more varieties of chili peppers. The non-alcoholic beverage composition may also comprise bell pepper, salt or garlic.

In yet another embodiment of the present invention, a non-alcoholic beverage composition comprises lime juice and one or more varieties of chili peppers. The non-alcoholic beverage composition may also comprise bell pepper, salt or garlic. Another preferred embodiment of the present invention comprises lime juice combined with one or more varieties of chili peppers, salt and beer to be consumed as an alcoholic beverage.

In still another embodiment of the present invention, an alcoholic beverage, such as beer, wine or spirits may be included in the beverage composition.

The invention also comprises a method of preparing a non-alcoholic beverage, the method comprising mixing a predetermined volume of lime juice with a fixed amount of one or more varieties of chili peppers. In a preferred embodiment of the invention, a predetermined amount of salt is also added. The non-alcoholic mixture is added to an alcoholic beverage, such as a beer, wine or spirit and is consumed as a specialty beverage.

### DETAILED SUMMARY

As used herein, the words or terms set forth below have the following definitions.

A beverage composition is defined as a drink other than water for human consumption.

Fruit juice is defined as the liquid extracted from a product of a tree or plant that contains a seed.

A chili pepper is defined as the fruit of plants from the genus Capsicum. Examples of a chili pepper include jalapeno, habanero, poblano, serrano, New Mexico, California, guindilla verde, chilaca, basque fryer, Anaheim, guernica, hot banana, pimiento de pardon, thai and shishito chili peppers.

Citrus juice is defined as the liquid extracted from a fruit of a tree from the Citrus genus. Examples of a citrus juice include lime juice, lemon juice, orange and grapefruit juice.

Lime juice is defined as the liquid extracted from the small globose yellowish green fruit of a spiny tropical tree of the genus Citrus (C. aurantifolia) that usually has an acidic juicy pulp.

Jalapeno chili pepper is defined as the fruit of a variety of Capsicum annuum originating from the Mexican state of Vera Cruz.

Habanero pepper is defined as the fruit of a variety of Capsicum chinense.

Poblano chili pepper is defined as the fruit of a variety of Capsicum annuum originating from the Mexican state of Puebla.

Serrano chili pepper is defined as the fruit of a variety of Capsicum annuum originating from the Mexican states of Puebla and Hidalgo.

New Mexico chili pepper is defined as the fruit of a variety of Capsicum annuum originating from the state of New Mexico.

Bell pepper is defined as the fruit of a variety of Capsicum annuum grossum.

Salt is defined as a crystalline compound consisting of sodium chloride.

Garlic is defined as the bulb portion of the Allium sativum plant.

An alcoholic beverage is defined as a composition containing alcohol for human consumption. Examples of alcoholic beverages include beer, wine and spirits.

Beer is defined as an alcoholic beverage made from a yeast fermented malted cereal grain flavored with hops.

Wine is defined an alcoholic drink made from fermented grape juice.

A spirit is defined as an alcohol-containing beverage produced by distilling ethanol produced by means of fermenting a grain, fruit or vegetable. Examples of a spirit include vodka, tequila and rum.

In one embodiment of the present invention, a beverage composition comprises a fruit juice and one or more varieties of chili pepper. The beverage composition can be combined with an alcoholic beverage to produce a specialty alcoholic mixed drink.

In another embodiment of the present invention, a beverage composition comprises a citrus juice and one or more varieties of chili pepper. The beverage composition can be combined with an alcoholic beverage to produce a specialty alcoholic mixed drink.

In another embodiment of the present invention, a beverage composition comprises lime juice and one or more varieties of chili pepper. The beverage composition can be combined with an alcoholic beverage to produce a specialty alcoholic mixed drink.

In another embodiment of the present invention, a beverage composition comprises lemon juice and one or more varieties of chili pepper. The beverage composition can be combined with an alcoholic beverage to produce a specialty alcoholic mixed drink.

In another embodiment of the present invention, lime juice is combined with serrano chili, jalapeno chili and salt to create a composition designed to be mixed with beer and served as an alcoholic beverage.

The present invention may also be embodied in a beverage composition comprising lime juice, one or more varieties if chili pepper and a fixed quantity of salt for flavor. The composition may also comprising lime juice, one or more varieties if chili pepper and a fixed amount of bell pepper or garlic for flavor.

In another embodiment of the present invention, a composition comprising lime juice, serrano chili, jalapeno chili and salt is prepared and sold as a non-alcoholic beverage mixer to be combined with beer before consumption.

In another embodiment of the present invention lime juice is combined with 20 to 50 percent by weight serrano chili, 20 to 50 percent by weight jalapeno chili and 1 to 10 percent by weight salt.

In another embodiment of the present invention lime juice is combined with 10 to 40 percent by weight serrano chili, 10 to 40 percent by weight jalapeno chili and 1 to 10 percent by weight salt.

In another embodiment of the present invention, lime juice is combined with a jalapeno pepper and a serrano pepper as a mixed beverage.

In another embodiment of the present invention, lime juice is combined with a jalapeno pepper and a serrano pepper to be mixed with an alcoholic beer and consumed as an alcoholic mixed beverage.

In another embodiment of the present invention, lime juice is combined with one or more varieties of chili peppers and garlic.

In another embodiment of the present invention, lime juice is combined with one or more varieties of chili peppers and a fixed quantity of bell pepper.

In another embodiment of the present invention, lime juice is combined with a jalapeno pepper, a serrano pepper and salt to be mixed with an alcoholic beer and consumed as an alcoholic mixed beverage.

Chili peppers may incorporated into the composition as pieces of chili pepper, powdered chili pepper, chili pepper essence or artificial chili pepper flavor.

Bell pepper may incorporated into the composition as pieces of bell pepper, powdered bell pepper, bell pepper essence or artificial bell pepper flavor.

Garlic may incorporated into the composition as pieces of garlic, powdered garlic, garlic essence or artificial garlic flavor.

Pre packaged beverage mixes may be non-alcoholic compositions or they may be sold with alcohol already added.

What is claimed is:

1. A beverage composition comprising:
a fruit juice; and
a chili pepper.

2. The beverage composition of claim 1, wherein said fruit juice is a citrus juice.

3. The beverage composition of claim 1, wherein said fruit juice is lime juice.

4. The beverage composition of claim 1, further comprising more than one chili pepper.

5. The beverage composition of claim 1, wherein said chili pepper is a jalapeno, a habanero, a poblano, a serrano, a New Mexico, a California, a guindilla verde, a chilaca, a basque fryer, an Anaheim, a guernica, a hot banana, a pimiento de pardon, a thai or a shishito chili pepper.

6. The beverage composition of claim 1, further comprising an alcoholic beverage.

7. The beverage composition of claim 6, wherein said alcoholic beverage is a beer, a wine or a spirit.

8. The beverage composition of claim 1, further comprising a bell pepper.

9. The beverage composition of claim 1, further comprising salt.

10. The beverage composition of claim 1, further comprising garlic.

11. A process for producing an alcoholic beverage composition comprising:
combing the beverage composition of claim 1 with a beer, wine or spirit to produce an alcoholic beverage composition.

12. The beverage composition of claim 1, further comprising two or more chili peppers.

13. The beverage composition of claim 12, wherein said chili peppers are a combination of a jalapeno, a habanero, a poblano, a serrano, a New Mexico, a California, a guindilla verde, a chilaca, a basque fryer, an Anaheim, a guernica, a hot banana, a pimiento de pardon, a thai or a shishito chili pepper.

14. A method of preparing a beverage composition, the method comprising:
measuring a quantity of lime juice;
adding two or more chili peppers to said lime juice;
and adding a measured quantity of salt to said beverage composition.
